(19) United States
(12) Patent Application Publication
(10) Pub. No.: US 2025/0182146 A1
(43) Pub. Date: Jun. 5, 2025

(54) CAFE CURATION DEVICE AND CAFE CURATION METHOD

(71) Applicant: MAZE INC., Hanam-si (KR)

(72) Inventors: Ki Sun SONG, Hanam-si (KR); Kyung Min KO, Hanam-si (KR)

(73) Assignee: MAZE INC., Hanam-si (KR)

(21) Appl. No.: 18/845,038

(22) PCT Filed: Mar. 2, 2023
(86) PCT No.: PCT/KR2023/002832

§ 371 Date: Sep. 9, 2024

(30) Foreign Application Priority Data
Mar. 24, 2022 (KR) 10-2022-0036959
Mar. 24, 2022 (KR) 10-2022-0036960
Oct. 31, 2022 (KR) 10-2022-0141946

(51) Int. Cl. G06Q 30/0202; G06Q 30/0204; G06Q 50/12

(52) U.S. Cl. CPC G06Q 30/0202; G06Q 30/0204; G06Q 50/12

(57) ABSTRACT

A cafe curation device and a cafe curation method are provided. A cafe curation device includes: a cafe monitoring data collection module configured to collect cafe monitoring data provided from an artificial intelligence-based cafe monitoring device installed in a cafe, wherein the cafe monitoring data includes at least one of status data and predicted data regarding inside of the cafe; a customer data collection module configured to collect customer data related to a customer from a customer terminal used by the customer; a status check signal transmission module configured to transmit a status check signal to the cafe monitoring device; a cafe curation scheme determination module configured to determine a cafe curation scheme; and a cafe list generation module configured to generate a cafe list.

### TECHNICAL FIELD

Disclosed relates to a cafe curation device and a cafe curation method.

### BACKGROUND ART

Cafe curation services involve collecting and selecting information about various cafes, adding new value, and disseminating it. When a cafe owner who wants to attract customers registers their cafe with a cafe curation service, customers can receive recommendations for cafes that match their preferences or visit purposes through a user terminal. Notably, cafe curation services distinguish themselves from previous cafe recommendation services by offering cafes that align with values important to the user, rather than merely providing information about nearby cafes based on the user terminal's location or cafes with high review ratings. To implement a more valuable cafe curation service, research is being conducted on methods to collect information about the real-time status or predicted status inside cafes and utilize this information in the cafe curation services.

### DISCLOSURE

The present disclosure addresses the need for a cafe curation device and a cafe curation method that can provide a cafe curation service to customers based on the current status data inside the cafe and predicted data collected through artificial intelligence and Internet of Things (IoT) based monitoring devices installed in the cafe.

A cafe curation device according to an embodiment may include: a cafe monitoring data collection module configured to collect cafe monitoring data provided from an artificial intelligence-based cafe monitoring device installed in a cafe, wherein the cafe monitoring data includes at least one of status data and predicted data regarding the inside of the cafe; a customer data collection module configured to collect customer data related to a customer from a customer terminal used by the customer; a status check signal transmission module configured to transmit a status check signal to the artificial intelligence-based cafe monitoring device; a cafe curation scheme determination module configured to determine a cafe curation scheme based on a response signal to the status check signal; and a cafe list generation module configured to generate a cafe list based on the determined cafe curation scheme and provide the cafe list to the customer terminal.

In some embodiments, the status data may include data related to at least one of table or seat arrangement status, table or seat occupancy status, noise status, status of music being played in a store, status of a playback history of in a store, visiting customer gender status, visiting customer age group status, visiting customer behavior status, visiting customer stay time status, order status by menu, and interior status inside the cafe; and the predicted data may include data related to at least one of predicted changes in table or seat occupancy rates, predicted seat ambiance, predicted wait times, predicted noise changes, predicted music to be played in the store, predicted visiting customer gender, predicted visiting customer age group, predicted visiting customer behavior patterns, predicted visiting purpose, predicted menu rankings, predicted recommended menu, predicted sales, predicted inventory, and predicted cafe atmosphere.

In some embodiments, the status data and the prediction data may be anonymized within the artificial intelligence-based cafe monitoring device.

In some embodiments, the customer data may include data related to at least one of customer gender, customer age, customer location, service usage history, customer preferences, preferred menu items, cafe visit history, and predicted visit purpose.

In some embodiments, a first scheme may include a scheme that uses both the status data and the prediction data for cafe curation, and when the response signal includes a first response signal, the cafe curation scheme determination module may be configured to determine the first scheme as the cafe curation scheme.

In some embodiments, a second scheme may include a scheme that uses the status data but does not use the prediction data for cafe curation, and when the response signal includes a second response signal different from the first response signal, the cafe curation scheme determination module may be configured to determine the second scheme as the cafe curation scheme.

In some embodiments, a third scheme may include a scheme that does not use both the status data and the prediction data for cafe curation, and when the response signal includes a third response signal different from the first response signal and the second response signal, the cafe curation scheme determination module may be configured to determine the third scheme as the cafe curation scheme.

In some embodiments, a fourth scheme may include a scheme that uses past cafe monitoring data collected by the cafe monitoring data collection module for cafe curation, and when the response signal includes the third response signal, the cafe curation scheme determination module may be configured to determine the third scheme and the fourth scheme as the cafe curation scheme.

In some embodiments, a fifth scheme may include a scheme that uses the customer data for curation, and the cafe curation scheme determination module may be configured to determine at least one of the first scheme through the fourth scheme and the fifth scheme as the cafe curation scheme.

In some embodiments, the cafe curation device may further include a digital twin generation module configured to generate the inside of the cafes included in the generated cafe list as a digital twin virtual space, and the cafe list generation module may be configured to operate in conjunction with the digital twin generation module to provide the inside of the cafes included in the cafe list to the customer terminal in the form of the digital twin virtual space.

In some embodiments, the digital twin generation module may be configured to update the digital twin virtual space by reflecting changes in the status data.

In some embodiments, the digital twin generation module may be configured to provide sound data corresponding to the inside of the cafes included in the generated cafe list to the customer terminal, allowing the customer terminal to play the sound data during the rendering of the digital twin virtual space.

In some embodiments, the digital twin generation module may be configured to update the sound data associated with the digital twin virtual space by reflecting changes in the status data.

In some embodiments, the cafe list generation module may be configured to provide prediction data related to the cafes included in the cafe list to the customer terminal, allowing the customer terminal to display the prediction data on the screen in the form of at least one of text, icons, images, and videos.

A cafe curation method according to an embodiment may include: collecting cafe monitoring data provided from an artificial intelligence-based cafe monitoring device installed in a cafe, wherein the cafe monitoring data includes at least one of status data and prediction data regarding the inside of the cafe; collecting customer data related to a customer from a customer terminal used by the customer; transmitting a status check signal to the artificial intelligence-based cafe monitoring device; determining a cafe curation scheme based on a response signal to the status check signal; and generating a cafe list based on the determined cafe curation scheme and providing the cafe list to the customer terminal.

In some embodiments, the cafe curation method may further include: creating a digital twin virtual space of the inside of the cafes included in the generated cafe list; and providing the inside of the cafes included in the cafe list to the customer terminal in the form of the digital twin virtual space.

In some embodiments, the cafe curation method may further include providing sound data related to the digital twin virtual space to the customer terminal.

In some embodiments, the cafe curation method may further include providing the prediction data related to the cafes included in the cafe list to the customer terminal, allowing the customer terminal to display the prediction data on the screen in the form of at least one of text, icons, images, and videos.

It is possible to provide a cafe curation service to customers based on the current status data inside the cafe and predicted data collected through artificial intelligence and Internet of Things (IoT) based monitoring devices installed in the cafe.

### DESCRIPTION OF THE DRAWINGS

FIG. 1 is a block diagram illustrating a cafe curation system according to an embodiment.

FIG. 2 is a block diagram illustrating an artificial intelligence-based cafe monitoring device according to an embodiment.

FIG. 3 is a block diagram illustrating a cafe curation device according to an embodiment.

FIG. 4 is a flowchart illustrating a cafe curation method according to an embodiment.

FIG. 5 is a block diagram illustrating the operation of a cafe curation device according to an embodiment.

FIG. 6 is a block diagram illustrating the operation of a cafe curation device according to an embodiment.

FIG. 7 is a block diagram illustrating the operation of a cafe curation device according to an embodiment.

FIG. 8 is a block diagram illustrating a cafe curation device according to an embodiment.

FIG. 9 is a flowchart illustrating a cafe curation method according to an embodiment.

FIG. 10 is a diagram illustrating an example of a screen displayed on a customer terminal according to an embodiment.

FIG. 11 is a block diagram illustrating a computing device according to an embodiment.

### MODE FOR INVENTION

Hereinafter, the embodiments of the present invention will be described in detail with reference to the accompanying drawings so that those skilled in the art to which the present invention pertains can easily implement them. However, the present invention is not limited to the embodiments described herein and may be implemented in various different forms. Moreover, in order to clearly describe the present invention in the drawings, parts irrelevant to the description have been omitted, and similar reference numerals have been used for similar parts throughout the specification.

In the entire specification and claims, when a part is described as “including” a certain component, it means that, unless specifically stated otherwise, the inclusion of other components is not excluded and that other components may be further included.

Furthermore, the terms such as “ . . . part,” “ . . . unit,” and “ . . . module” described in the specification may refer to units capable of processing at least one function or operation as described herein, and these units may be implemented as hardware, software, or a combination of hardware and software.

In the present specification, embodiments are described with cafes as examples for the sake of clarity in explanation. However, the scope of the present invention extends to any store or space where IoT devices are used to monitor the real-time status inside the store or space and to curate, recommend, or suggest the store or space to users based on the predicted status, even if the store or space is not a cafe.

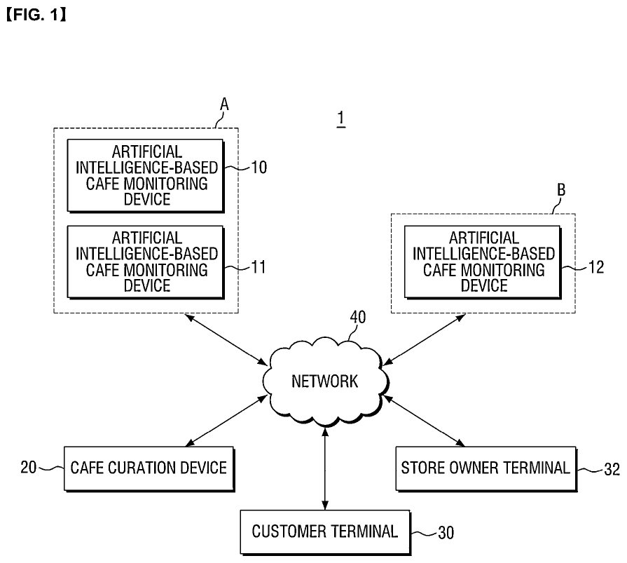

FIG. 1 is a block diagram illustrating a cafe curation system according to an embodiment.

Referring to FIG. 1, a cafe curation system 1 according to an embodiment may include artificial intelligence-based cafe monitoring devices 10, 11, 12, a cafe curation device 20, a customer terminal 30, and a store owner terminal 32. The artificial intelligence-based cafe monitoring devices 10, 11, 12, the cafe curation device 20, the customer terminal 30, and the store owner terminal 32 may exchange data with each other via a network 40.

The artificial intelligence-based cafe monitoring devices 10, 11, 12 may be IoT devices. IoT is a technology that integrates sensing and communication functions into objects to connect them to the internet. The artificial intelligence-based cafe monitoring devices 10, 11, 12 are installed inside the cafe to monitor the inside of the cafe and may transmit the monitoring results to other devices, for example, the cafe curation device 20, via the network 40. The artificial intelligence-based cafe monitoring devices 10, 11, 12 may be equipped with an artificial intelligence model (for example, a deep learning model) to monitor the inside of the cafe and may be installed inside multiple cafes to monitor the real-time status inside and to predict the future status. For example, the artificial intelligence-based cafe monitoring devices 10, 11 may be installed inside a cafe A to monitor and predict the status inside cafe A, and the artificial intelligence-based cafe monitoring device 12 may be installed inside another cafe B to monitor and predict the status inside cafe B. The monitoring and prediction results obtained from the artificial intelligence-based cafe monitoring devices 10, 11 installed inside cafe A and the monitoring and prediction results obtained from the monitoring device 12 installed inside cafe B may be transmitted to the cafe curation device 20 via the network 40. Hereinafter, a detailed description will be provided regarding the cafe curation device 20 when the artificial intelligence-based cafe monitoring devices 10, 11, 12 installed inside cafes A and B provide the monitoring and prediction results as cafe monitoring data to the cafe curation device 20.

The cafe curation device 20 may present cafes that align with the values customers consider important when selecting a cafe to the customers via the customer terminal 30, based on the cafe monitoring data related to cafes A and B collected through the cafe monitoring devices 10, 11, 12. In some embodiments, the cafe monitoring data collected through the cafe monitoring devices 10, 11, 12 may be stored and managed in a database that the cafe curation device 20 may access.

In some embodiments, the cafe monitoring data may include at least one of current status data and predicted data related to the inside of the cafe. The current status data may include information about the inside of the cafe, which is collected by the artificial intelligence-based cafe monitoring devices 10, 11, 12 using sensors such as cameras and microphones, as well as artificial intelligence technologies like object detection, pose estimation, and semantic segmentation. Specifically, the current status data may include data related to at least one of the following: table or seat arrangement status, table or seat occupancy status, noise status, status of music being played in the store, playback history of music in the store, visiting customer gender status, visiting customer age group status, visiting customer behavior status, visiting customer stay time status, order status by menu, and interior status inside the cafe. On the other hand, the predicted data may include data inferred, derived, or predicted based on information about the inside of the cafe collected through sensors and an artificial intelligence inference model, or data estimated from accumulated current status data. Specifically, the predicted data may include data related to at least one of the following: predicted changes in table or seat occupancy rates, predicted seat ambiance, predicted wait times, predicted noise changes, predicted music to be played in the store, predicted visiting customer gender, predicted visiting customer age group, predicted visiting customer behavior patterns, predicted visiting purpose, predicted menu rankings, predicted recommended menu, predicted sales, predicted inventory, and predicted cafe atmosphere.

For example, predicted data related to sales predictions may be estimated from current status data related to order status by menu, and predicted data related to visiting customer behavior patterns (e.g., 30% working on a computer, 20% conversing, 50% resting), visiting purpose predictions, or wait time predictions may be inferred from current status data related to visiting customer behavior status and visiting customer stay time status. In another example, predicted data related to seat ambiance predictions, visiting customer gender predictions, or visiting customer age group predictions may be inferred from current status data related to visiting customer gender status or visiting customer age group status. In yet another example, predicted data related to noise change predictions, predictions of music to be played in the store, or cafe ambiance predictions may be inferred from current status data related to noise status, the music being played in the store, or the playback history of music in the store.

In some embodiments, the current status data and predicted data may be fully generated by the artificial intelligence-based cafe monitoring devices 10, 11, 12 and then transmitted to the cafe curation device 20. In other embodiments, some of the current status data and predicted data may be generated by the artificial intelligence-based cafe monitoring devices 10, 11, 12 and transmitted to the cafe curation device 20, while other parts of the predicted data may be generated by the cafe curation device 20 from the cafe monitoring data transmitted to it.

In some embodiments, the cafe monitoring data, including current status data and predicted data, may undergo anonymization processing within the artificial intelligence-based cafe monitoring devices 10, 11, 12. That is, the cafe monitoring data generated by the artificial intelligence-based cafe monitoring devices 10, 11, 12 may be anonymized during the process of being generated into various types of data as described above, or after the generation is completed, so that data capable of identifying individuals may not be transmitted to the cafe curation device 20. As one implementation example, if data related to gender and the number of individuals is extracted from image data capturing visitors inside the cafe, only the data related to gender and the number of individuals may be transmitted to the cafe curation device 20, and the image data may be destroyed within the artificial intelligence-based cafe monitoring devices 10, 11, 12. Accordingly, it may be possible to implement privacy protection while also enabling the monitoring and prediction of the status inside the cafe.

In some embodiments, the cafe monitoring data may be implemented as text data following a specific format. For example, the cafe monitoring data may be organized and abstracted into text data with a specific format, such as JSON, as “3 people at table 1, 1 person at table 3, 2 lattes, 3 iced americanos, 3 women, 2 men.”

In some embodiments, one type of cafe monitoring data provided by the artificial intelligence-based cafe monitoring devices 10, 11, 12 to the cafe curation device 20 may be transmitted to the cafe curation device 20 in real-time. Specifically, the artificial intelligence-based cafe monitoring devices 10, 11, 12 may transmit one type of cafe monitoring data to the cafe curation device 20 at a predetermined first time interval (for example, every 20 seconds). Here, the predetermined time interval may be set differently depending on the specific implementation purpose and implementation environment. On the other hand, another type of cafe monitoring data provided by the artificial intelligence-based monitoring devices 10, 11, 12 to the cafe curation device 20 may be transmitted to the cafe curation device 20 at a predetermined second time interval (for example, several hours, several days) that is longer than the first time interval. That is, one type of cafe monitoring data, which needs to be frequently updated for the cafe curation device 20 to provide services, may be transmitted in real-time or at short time intervals, while another type of cafe monitoring data, which does not need to be frequently updated, may be transmitted at relatively long time intervals. This allows for the efficient use of network bandwidth and the reduction of power consumption by the artificial intelligence-based cafe monitoring devices 10, 11, 12.

For example, among the current status data, data related to the status of table or seat arrangement, table or seat occupancy status, noise status, and the status of music being played in the store may correspond to the one type of cafe monitoring data that needs to be updated immediately in the cafe curation service. On the other hand, data related to the status of visiting customer gender, visiting customer age group, visiting customer behavior, visiting customer stay time, order status by menu, and interior status inside the cafe may correspond to the another type of cafe monitoring data, for which immediate updates are not critical. Of course, such classifications are exemplary, and the specific classifications may vary depending on the specific implementation purpose and implementation environment.

As another example, among the predicted data, data related to the prediction of changes in table or seat occupancy rates, seat ambiance predictions, wait time predictions, noise change predictions, and predictions of music to be played in the store may correspond to the one type of cafe monitoring data that needs to be updated immediately in the cafe curation service. On the other hand, data related to predictions of visiting customer gender, visiting customer age group predictions, visiting customer behavior pattern predictions, visiting purpose predictions, menu ranking predictions, recommended menu predictions, sales predictions, inventory predictions, and cafe ambiance predictions may correspond to the another type of cafe monitoring data, for which immediate updates are not critical. Of course, such classifications are exemplary, and the specific classifications may vary depending on the specific implementation purpose and implementation environment.

As another example, the current status data may be classified as one type of cafe monitoring data that is transmitted in real-time or at short time intervals, and the predicted data may be classified as another type of cafe monitoring data that is transmitted at relatively long time intervals. Of course, such classifications are exemplary, and the specific classifications may vary depending on the specific implementation purpose and implementation environment.

In some embodiments, the artificial intelligence-based cafe monitoring devices 10, 11, 12 may adjust the frequency of transmitting information to the cafe curation device 20, taking into account computing and network resources. For example, the artificial intelligence-based cafe monitoring devices 10, 11, 12 may average the monitoring and prediction results obtained at three different times, namely the first time, the second time, and the third time, in order to use computing and network resources efficiently, and may transmit the averaged result only once to the cafe curation device 20.

In some embodiments, the artificial intelligence-based cafe monitoring devices 10, 11, 12 may be equipped with a processor for monitoring and predicting the status inside the cafe based on an artificial intelligence inference model. However, since efficient operation of computing resources is often required in the environment where the artificial intelligence-based cafe monitoring devices 10, 11, 12 are installed, the processor may be used in a sophisticated manner. Specifically, the artificial intelligence-based cafe monitoring devices 10, 11, 12 may control the processor to use only the object detection function to obtain certain data from the cafe monitoring data, may control the processor to use both the object detection function and the pose estimation function to obtain other data, and may also control the processor to use both the object detection function and the semantic segmentation function to obtain yet another type of data. By mixing and using these functions-object detection, pose estimation, and semantic segmentation—according to the characteristics of the data to be obtained, it may be possible to efficiently operate the limited computing resources of the artificial intelligence-based cafe monitoring devices 10, 11, 12.

For example, regarding data related to seat occupancy status, such as data on table or seat arrangement status, table or seat occupancy status, and predictions of changes in table or seat occupancy rates, as well as data related to customer appearance inference, such as data on visiting customer gender status, visiting customer age group status, predictions of visiting customer gender, and predictions of visiting customer age group, the processor may be controlled to use both the object detection function and the semantic segmentation function together. Of course, such classifications are exemplary, and the specific classifications may vary depending on the specific implementation purpose and implementation environment.

As another example, regarding data related to customer behavior inference, such as data on visiting customer behavior status, visiting customer stay time status, predictions of visiting customer behavior patterns, and predictions of visiting purpose, the processor may be controlled to use both the object detection function and the pose estimation function together. Of course, such classifications are exemplary, and the specific classifications may vary depending on the specific implementation purpose and implementation environment.

As another example, regarding data related to menu or sales estimation, such as data on order status by menu, menu ranking predictions, recommended menu predictions, sales predictions, and inventory predictions, the processor may be controlled to use only the object detection function. Of course, such classifications are exemplary, and the specific classifications may vary depending on the specific implementation purpose and implementation environment.

The customer terminal 30 may receive a curated list of cafes from the cafe curation device 20 and may provide a cafe curation service to the customer. To achieve this, the customer terminal 30 may provide customer data associated with the customer using the customer terminal 30 to the cafe curation device 20, allowing the cafe curation device 20 to use the customer data along with the cafe monitoring data when providing the cafe curation service. As a result, the cafe curation device 20 may analyze the correlation between the cafe monitoring data and the customer data, enabling it to discover and recommend cafes that can provide actual satisfaction to the customer, rather than merely selecting cafes that are close to the current location or well-known franchise cafes.

In some embodiments, the customer data may include data related to at least one of customer gender, customer age, customer location, service usage history, customer preferences, preferred menu items, preferred music genres, cafe visit history, and predicted visit purpose. The store owner terminal 32, which is used by the cafe owner, may provide functions such as registering cafe information and menu information in the cafe curation service or processing orders when orders are received from customers through the cafe curation service.

In some embodiments, the customer terminal 30 and the store owner terminal 32 may be computing devices such as smartphones, tablet computers, wearable devices, laptop computers, desktop computers, and the like. Users may utilize the cafe curation service through an application running on the customer terminal 30 and the store owner terminal 32.

The network 40 may include a wireless network such as a Wi-Fi network, Bluetooth network, cellular network, a wired network such as a Local Area Network (LAN), or a network that is a combination of wireless and wired networks.

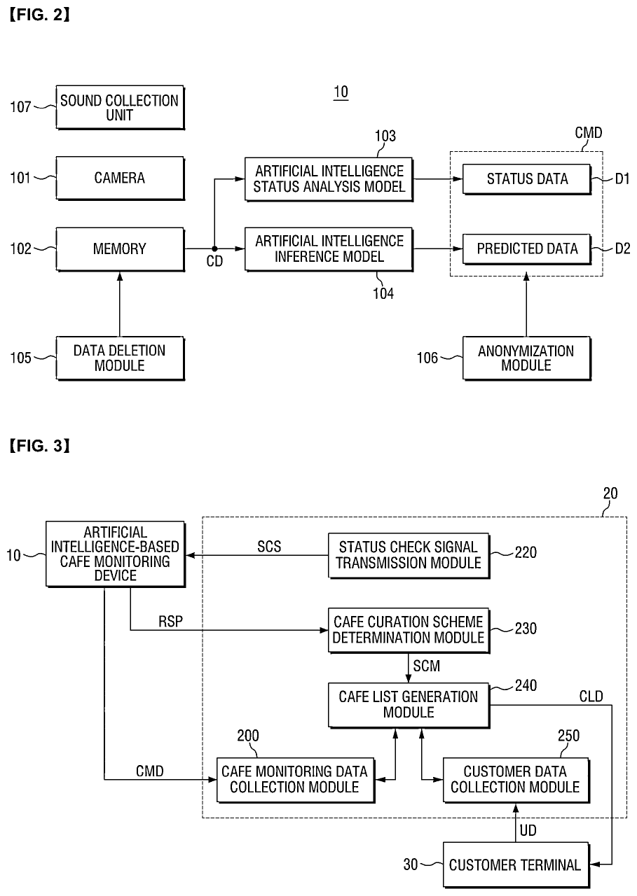

Hereinafter, the cafe curation device and the cafe curation method according to the embodiments will be described in detail with reference to FIGS. 2 to 10.

FIG. 2 is a block diagram illustrating an artificial intelligence-based cafe monitoring device according to one embodiment.

Referring to FIG. 2, an artificial intelligence-based cafe monitoring device 10 according to one embodiment may include a camera 101, a memory 102, an artificial intelligence status analysis model 103, an artificial intelligence inference model 104, a data deletion module 105, and an anonymization module 106. In this specification, the description of the artificial intelligence-based cafe monitoring device 10 may be equally applied to the artificial intelligence-based cafe monitoring devices 11 and 12.

The camera 101 may capture the inside of the cafe and output captured data that includes images or videos. In some embodiments, the camera 101 may include PTZ cameras capable of pan, tilt, and zoom functions, or fixed cameras. In other embodiments, the camera 101 may include RGB cameras, IR cameras, and the like. To capture the inside of the cafe without blind spots, multiple cameras 101 may be installed in the cafe, and these may exchange data with each other through the network 40. Additionally, the capturing of the inside of the cafe using the camera 101 may be conducted extensively, including seats, tables, visiting customers, the floor, walls, and ceiling

In some embodiments, the camera 101 may include multiple cameras with different assigned roles. For example, among multiple cameras capturing the same cafe, one camera may be responsible for capturing seats or tables, another camera may be responsible for capturing visiting customers, and yet another camera may be assigned to capture the interior, including the floor, walls, and ceiling.

The memory 102 may load the software and data necessary for the operation of the artificial intelligence-based cafe monitoring device 10. Specifically, the memory 102 may load program code for performing status monitoring and prediction of the inside of the cafe using the artificial intelligence status analysis model 103 and the artificial intelligence inference model 104, or program code for implementing the functions of the data deletion module 105 and the anonymization module 106, which will be described later. Additionally, the memory 102 may load program code corresponding to the firmware or operating system that controls the overall operation of the artificial intelligence-based cafe monitoring device 10. Furthermore, the captured data output from the camera 101 may be loaded into the memory 102, and the artificial intelligence status analysis model 103 and the artificial intelligence inference model 104 may access the captured data loaded in the memory 102 as camera data CD to perform status monitoring and prediction of the inside of the cafe, and generate cafe monitoring data CMD that includes status data D1 and predicted data D2.

The artificial intelligence status analysis model 103 may generate status data D1 based on the camera data CD. That is, the artificial intelligence status analysis model 103 may generate status data D1 related to the inside of the cafe based on the camera data CD that includes images or videos. To achieve this, the artificial intelligence status analysis model 103 may include a deep learning model for implementing object detection, pose estimation, semantic segmentation, and the like.

In some embodiments, the artificial intelligence status analysis model 103 may analyze the status of empty tables or seats in the store based on the camera data CD that includes the store's tables or seats. Here, the status of empty tables or seats may include not only the occupancy rate of tables or seats but also information about the attributes of the empty tables or seats and information about the surrounding attributes of the empty tables or seats. The attributes of the empty tables or seats may include the location of the empty tables or seats inside the store, the type of empty seats (e.g., single chair, two-person sofa), and the surrounding attributes of the empty tables or seats may include the behavior patterns of other customers seated nearby or the level of noise around the empty tables or seats.

The artificial intelligence inference model 104 may generate predicted data D2 based on the camera data CD. That is, the artificial intelligence inference model 104 may generate predicted data D2 based on the camera data CD that includes images or videos. Here, the predicted data may include data inferred, derived, or predicted based on at least one of the camera data CD and the status data D1, or data estimated from accumulated status data. To achieve this, the artificial intelligence inference model 104 may also include a deep learning model.

In some embodiments, the artificial intelligence inference model 140 may analyze the purpose of a visiting customer's visit, such as whether the purpose is to rest, work on a laptop, work on documents, converse with a companion, meet someone, or read. This analysis may take as input the camera data CD that includes the visiting customer and may be implemented by the artificial intelligence inference model 140, which has been trained to output categorized visit purposes such as “rest,” “laptop work,” “paperwork,” “conversation,” “meeting,” and “reading.”

In other embodiments, the artificial intelligence inference model 140 may analyze the interior of the store by analyzing the captured results that include the floor, walls, and ceiling. Specifically, it may analyze the interior atmosphere based on the colors, patterns, and other features of the floor, walls, and ceiling. This analysis may take as input the camera data CD related to the interior of the store, such as the floor, walls, and ceiling, and may be implemented by the artificial intelligence inference model 140, which has been trained to output categorized interior atmospheres such as “nature-friendly interior,” “modern interior,” and “office space-like interior.”

The data deletion module 105 may delete the camera data CD that was used by the artificial intelligence status analysis model 103 and the artificial intelligence inference model 104 to generate the cafe monitoring data CMD, thereby securely performing the deletion of images and videos used for generating the cafe monitoring data CMD for privacy protection.

The anonymization module 106 may perform anonymization processing on the cafe monitoring data CMD. That is, the anonymization module 106 may delete or modify data that could potentially identify individuals during the process of generating the cafe monitoring data CMD, or after the cafe monitoring data CMD has been generated, so that information related to identity is not transmitted when the cafe monitoring data CMD is provided to the cafe curation device 20.

In some embodiments, the artificial intelligence-based cafe monitoring device 10 according to one embodiment may further include a sound collection unit 107. The sound collection unit 107 may include a microphone capable of measuring or recording sounds occurring in the store. The sound collection unit 107 may collect not only noise and ambient sounds occurring in the store but also sounds related to the music being played in the store, and may transmit the collected sound data to the memory 102. Once the sound data is loaded into the memory 102, the artificial intelligence status analysis model 103 may generate status data D1 based on the sound data, including the noise status in the store, the identification results of the music being played in the store, and the analysis of the visiting customers' gender status inferred from their voices in the sound data. Meanwhile, the artificial intelligence inference model 104 may generate predicted data D2 based on the sound data, including noise change predictions, predictions of the music to be played in the store, predictions of the cafe's interior atmosphere, and further, gender predictions of visiting customers inferred from the analysis of their voices in the sound data.

In some embodiments, the sound collection unit 107 may be implemented outside the artificial intelligence-based cafe monitoring device 10. Specifically, the sound collection unit 107 may be implemented in the form of a sound analysis application capable of collecting sounds within the store, and may be installed and executed on the store owner terminal 32 shown in FIG. 1. Alternatively, the sound collection unit 107 may be implemented as a separate hardware device from the artificial intelligence-based cafe monitoring device 10 and may be installed at various points inside the cafe. When the sound collection unit 107 is implemented outside the artificial intelligence-based cafe monitoring device 10 in this manner, the store owner terminal 32 or the hardware device may be equipped with components corresponding to the artificial intelligence status analysis model 103 and the artificial intelligence inference model 104 of the artificial intelligence-based cafe monitoring device 10. These devices may generate status data D1 related to noise status within the store, identification results of music being played in the store, and visiting customer gender status inferred from voices in the sound data, as described above. They may also generate predicted data D2 related to noise change predictions, predictions of music to be played in the store, predictions of the cafe's interior atmosphere, and further, gender predictions of visiting customers inferred from the analysis of their voices in the sound data.

In some embodiments, the sound collection unit 107 may include multiple sound collection units 107, and through difference analysis of the sound data collected by the multiple sound collection units 107, accurate sound detection may be implemented. Specifically, by performing difference analysis between the first sound data collected through the sound collection unit 107 implemented on the store owner terminal 32 and the second sound data collected through a hardware device implemented as a separate device from the artificial intelligence-based cafe monitoring device 10 at a certain point inside the cafe, the noise level may be measured more precisely, and the music being played in the store may be identified more accurately amidst the noise.

In some embodiments, the identification of music being played in the store may be implemented using an API (Application Programming Interface) that provides services through a deep learning model, or it may be implemented by embedding a deep learning model, such as a Recurrent Neural Network (RNN), within the sound collection unit 107 specifically for music identification.

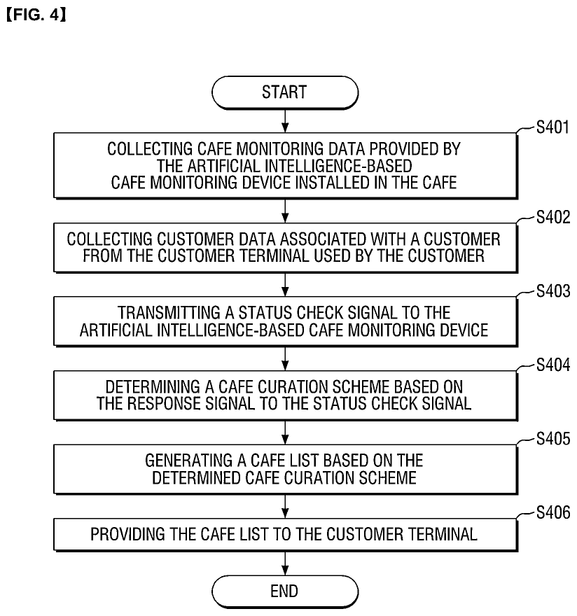

FIG. 3 is a block diagram illustrating a cafe curation device according to an embodiment.

Referring to FIG. 3, a cafe curation device 20 according to one embodiment may include a cafe monitoring data collection module 200, a status check signal transmission module 220, a cafe curation scheme determination module 230, a cafe list generation module 240, and a customer data collection module 250.

The cafe monitoring data collection module 200 may collect the cafe monitoring data CMD provided by the artificial intelligence-based cafe monitoring device 10 installed in the cafe. As described above, the cafe monitoring data CMD may include at least one of status data and predicted data. In some embodiments, the cafe monitoring data collection module 200 may store and manage the cafe monitoring data CMD received from the artificial intelligence-based cafe monitoring device 10 via the network 40 for each cafe using a database or storage.

The status check signal transmission module 220 may transmit a status check signal SCS to the artificial intelligence-based cafe monitoring device 10. Here, the status check signal SCS may be a signal for checking the operational mode of the artificial intelligence-based cafe monitoring device 10 through the network 40. The artificial intelligence-based cafe monitoring device 10 may transmit a response signal RSP to the cafe curation scheme determination module 230 in response to the status check signal SCS.

The response signal RSP to the status check signal SCS may include a first response signal, a second response signal, and a third response signal. The first response signal may indicate that the artificial intelligence-based cafe monitoring device 10 is in a first operational mode, where it provides both the status data D1 and the predicted data D2 from the cafe monitoring data CMD to the cafe curation device 20. Alternatively, the second response signal may indicate that the artificial intelligence-based cafe monitoring device 10 is in a second operational mode, where it provides only the status data D1 from the cafe monitoring data CMD to the cafe curation device 20 but does not provide the predicted data D2. The second operational mode may occur, for example, when only the artificial intelligence status analysis model 103 is operating on the artificial intelligence-based cafe monitoring device 10 and the artificial intelligence inference model 104 is not able to operate, or when the artificial intelligence inference model 104 on the artificial intelligence-based cafe monitoring device 10 has been intentionally set not to operate.

Alternatively, the third response signal may indicate that the artificial intelligence-based cafe monitoring device 10 is in a third operational mode, where it does not provide any of the cafe monitoring data CMD to the cafe curation device 20. The third operational mode may occur, for example, when neither the artificial intelligence status analysis model 103 nor the artificial intelligence inference model 104 is able to operate, or when they have been intentionally set not to operate on the artificial intelligence-based cafe monitoring device 10. However, this operational mode may also represent situations where the artificial intelligence-based cafe monitoring device 10 is unable to transmit the cafe monitoring data CMD to the cafe curation device 20, such as when the artificial intelligence-based cafe monitoring device 10 is malfunctioning, is unable to operate normally, or when a connection through the network 40 cannot be established.

The cafe curation scheme determination module 230 may determine a cafe curation scheme SCM based on the response signal RSP received from the artificial intelligence-based cafe monitoring device 10 in response to the status check signal SCS. Here, the cafe curation scheme SCM may allow the cafe curation device 20 to specify various methods for performing cafe curation.

For example, the cafe curation scheme SCM may include a first scheme, where the cafe curation device 20 uses both the status data D1 and the predicted data D2 from the cafe monitoring data CMD when performing cafe curation. In another example, the cafe curation scheme SCM may include a second scheme, where the cafe curation device 20 uses the status data D1 from the cafe monitoring data CMD but does not use the predicted data D2 when performing cafe curation. In yet another example, the cafe curation scheme SCM may include a third scheme, where the cafe curation device 20 does not use either the status data D1 or the predicted data D2 from the cafe monitoring data CMD when performing cafe curation. In another example, the cafe curation scheme SCM may include a fourth scheme, where the cafe curation device 20 uses past cafe monitoring data CMD collected by the cafe monitoring data collection module 200 when performing cafe curation. In yet another example, the cafe curation scheme SCM may include a fifth scheme, where the cafe curation device 20 uses customer data UD when performing cafe curation. Of course, the scope of the present invention is not limited to the listed examples, and the cafe curation scheme SCM may be variously configured depending on the specific implementation purpose and implementation environment.

In some embodiments, when the response signal RSP received from the artificial intelligence-based cafe monitoring device 10 includes the first response signal, the cafe curation scheme determination module 230 may determine the first scheme as the cafe curation scheme SCM. As mentioned above, the first response signal indicates that the artificial intelligence-based cafe monitoring device 10 provides both the status data D1 and the predicted data D2 from the cafe monitoring data CMD, so the cafe curation device 20 may perform cafe curation using both the status data D1 and the predicted data D2 from the cafe monitoring data CMD.

In other embodiments, when the response signal RSP received from the artificial intelligence-based cafe monitoring device 10 includes a second response signal different from the first response signal, the cafe curation scheme determination module 230 may determine the second scheme as the cafe curation scheme SCM. As mentioned above, the second response signal indicates that the artificial intelligence-based cafe monitoring device 10 provides only the status data D1 from the cafe monitoring data CMD and does not provide the predicted data D2, so the cafe curation device 20 may perform cafe curation using only the status data D1 from the cafe monitoring data CMD.

In other embodiments, when the response signal RSP received from the artificial intelligence-based cafe monitoring device 10 includes a third response signal different from the first and second response signals, the cafe curation scheme determination module 230 may determine the third scheme as the cafe curation scheme SCM. As mentioned above, the third response signal indicates that the artificial intelligence-based cafe monitoring device 10 does not provide any of the cafe monitoring data CMD, so the cafe curation device 20 may perform cafe curation without using the cafe monitoring data CMD.

In other embodiments, when the response signal RSP received from the artificial intelligence-based cafe monitoring device 10 includes the third response signal, the cafe curation scheme determination module 230 may determine the third scheme along with the fourth scheme as the cafe curation scheme SCM. In this case, the cafe curation device 20 may perform cafe curation using past cafe monitoring data CMD collected by the cafe monitoring data collection module 200.

In other embodiments, the cafe curation scheme determination module 230 may determine the fifth scheme as the cafe curation scheme SCM in conjunction with at least one of the first through fourth schemes. In this case, cafe curation may be performed using at least one of the status data D1, predicted data D2, and past cafe monitoring data CMD collected by the cafe monitoring data collection module 200, along with the customer data UD.

The cafe list generation module 240 may generate a cafe list based on the cafe curation scheme SCM determined by the cafe curation scheme determination module 230 and provide it to the customer terminal 30 as cafe list data CLD.

The customer data collection module 250 may collect customer data UD associated with the customer from the customer terminal 30 used by the customer, allowing the cafe curation device 20 to use the customer data along with the cafe monitoring data when providing the cafe curation service. Additionally, the customer data collection module 250 may display the cafe list provided by the cafe list generation module 240 on the screen, enabling the customer to discover and be recommended cafes.

In some embodiments, the cafe curation device 20 may perform cafe recommendations based on customer data UD or general user data. For example, while a customer is visiting a cafe, the cafe curation device 20 may inquire about the purpose of the visit through the customer terminal 30 and store the response as customer data UD. Later, the cafe curation device 20 may analyze the stored data and infer that the customer primarily engages in paperwork when visiting a cafe on weekday mornings. Therefore, if the customer searches for a cafe on a weekday morning, the cafe curation device 20 may prioritize recommending cafes whose interior is deemed suitable for paperwork. Alternatively, if the analysis of general user data obtained from various users indicates that the primary purpose of visiting a cafe on weekday mornings is to meet with others, the cafe curation device 20 may prioritize recommending cafes whose interior is deemed suitable for meetings when the customer searches for a cafe during this time.

In other words, selecting the cafe candidates to be included in the cafe list may be done based on user data specific to the customer or based on general user data. Here, the user data specific to the customer may be collected from the questions asked and responses given by the customer during their past visits to cafes. For example, if the customer was asked about the purpose of their visit during a cafe visit and provided a response, the response content, response time (or cafe visit time), and response location may be stored as part of that customer's data UD. General user data may be data obtained by the cafe curation device 30 from various anonymous users.

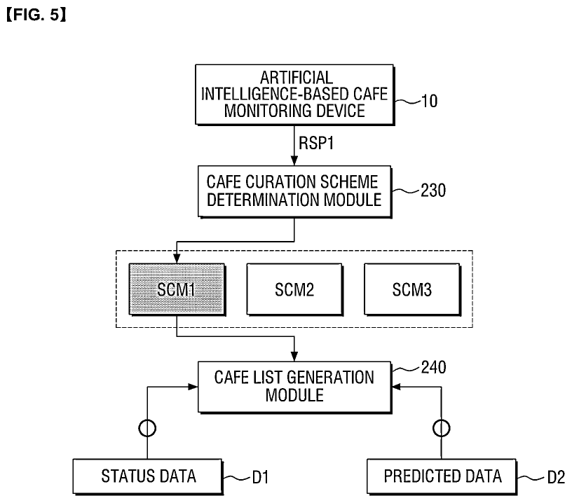

FIG. 4 is a flowchart illustrating a cafe curation method according to an embodiment.

Referring to FIG. 4, a cafe curation method according to one embodiment may involve, in step S401, collecting cafe monitoring data provided by the artificial intelligence-based cafe monitoring device installed in the cafe, and in step S402, collecting customer data associated with a customer from the customer terminal used by the customer. The method may further involve, in step S403, transmitting a status check signal to the artificial intelligence-based cafe monitoring device, and in step S404, determining a cafe curation scheme based on the response signal to the status check signal. Additionally, the method may involve, in step S405, generating a cafe list based on the determined cafe curation scheme, and in step S406, providing the cafe list to the customer terminal.

For more detail regarding the cafe curation method according to one embodiment, reference may be made to the descriptions provided above in connection with FIGS. 1 to 3. Therefore, redundant explanations will be omitted here.

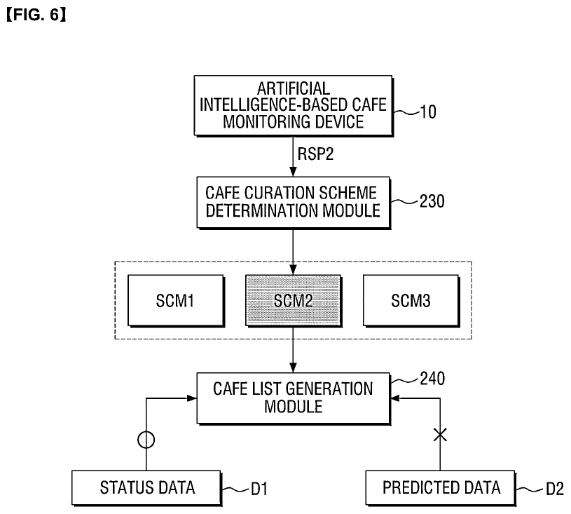

FIG. 5 is a block diagram illustrating the operation of a cafe curation device according to an embodiment.

Referring to FIG. 5, a cafe curation device 20 according to one embodiment may store multiple predefined schemes SCM1, SCM2, SCM3 in, for example, memory, registers, storage, or a database. The cafe curation scheme determination module 230 may receive a first response signal RSP1 from the artificial intelligence-based cafe monitoring device 10 and, based on the first response signal RSP1, may select the first scheme SCM1 from the multiple predefined schemes SCM1, SCM2, SCM3. The cafe curation scheme determination module 230 may then pass the selected first scheme SCM1 to the cafe list generation module 240 as the cafe curation scheme SCM, and the cafe list generation module 240 may generate a cafe list using both the status data D1 and the predicted data D2 from the cafe monitoring data CMD according to the first scheme SCM1.

The cafe list generation module 240 may provide the generated cafe list to the customer terminal 30, and the customer terminal 30 may display on the screen, along with the cafe list, an indication that both the status data D1 and the predicted data D2 from the cafe monitoring data CMD were used, in the form of text, icons, images, or videos, or at least one of these forms.

FIG. 6 is a block diagram illustrating the operation of a cafe curation device according to an embodiment.

Referring to FIG. 6, in a cafe curation device 20 according to one embodiment, the cafe curation scheme determination module 230 may receive a second response signal RSP2 from the artificial intelligence-based cafe monitoring device 10 and, based on the second response signal RSP2, may select the second scheme SCM2 from the multiple predefined schemes SCM1, SCM2, SCM3. The cafe curation scheme determination module 230 may then pass the selected second scheme SCM2 to the cafe list generation module 240 as the cafe curation scheme SCM, and the cafe list generation module 240 may generate a cafe list using only the status data D1 from the cafe monitoring data CMD, without using the predicted data D2, according to the second scheme SCM2.

The cafe list generation module 240 may provide the generated cafe list to the customer terminal 30, and the customer terminal 30 may display on the screen, along with the cafe list, an indication that only the status data D1 from the cafe monitoring data CMD was used and that the predicted data D2 was not used, in the form of text, icons, images, or videos, or at least one of these forms.

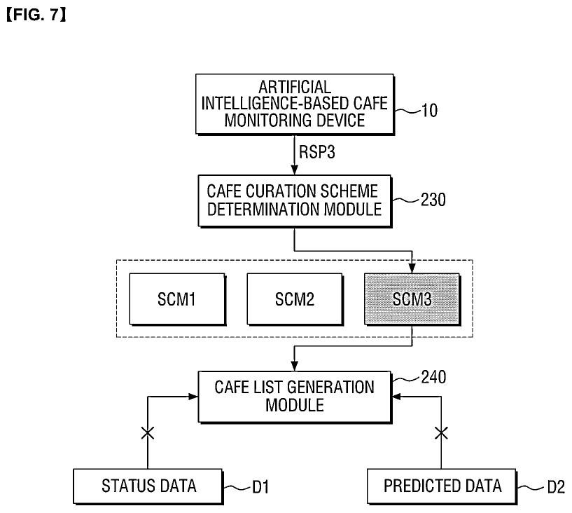

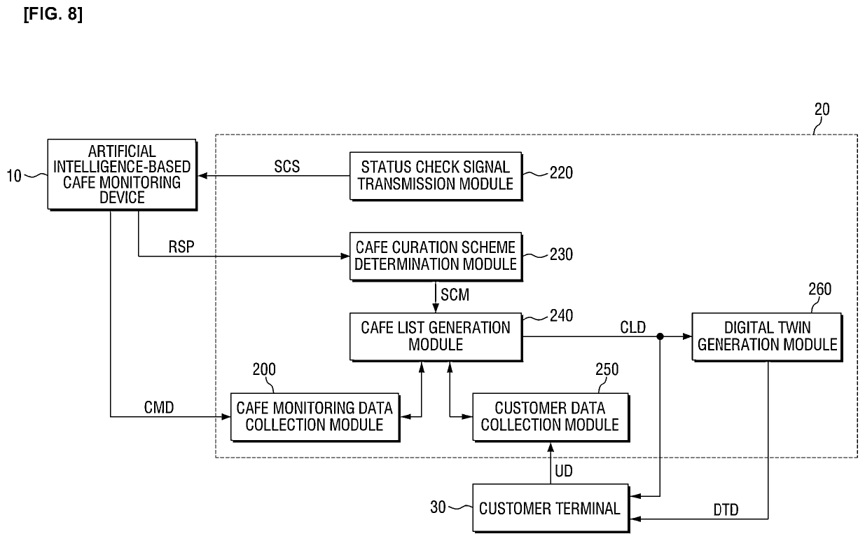

FIG. 7 is a block diagram illustrating the operation of a cafe curation device according to an embodiment.

Referring to FIG. 7, in a cafe curation device 20 according to one embodiment, the cafe curation scheme determination module 230 may receive a third response signal RSP3 from the artificial intelligence-based cafe monitoring device 10 and, based on the third response signal RSP3, may select the third scheme SCM3 from the multiple predefined schemes SCM1, SCM2, SCM3. The cafe curation scheme determination module 230 may then pass the selected third scheme SCM3 to the cafe list generation module 240 as the cafe curation scheme SCM, and the cafe list generation module 240 may generate a cafe list without using the cafe monitoring data CMD according to the third scheme SCM3.

The cafe list generation module 240 may provide the generated cafe list to the customer terminal 30, and the customer terminal 30 may display on the screen, along with the cafe list, an indication that the cafe monitoring data CMD was not used, in the form of text, icons, images, or videos, or at least one of these forms. Alternatively, it may display an indication that past cafe monitoring data CMD collected by the cafe monitoring data collection module 200 was used, in the form of text, icons, images, or videos, or at least one of these forms.

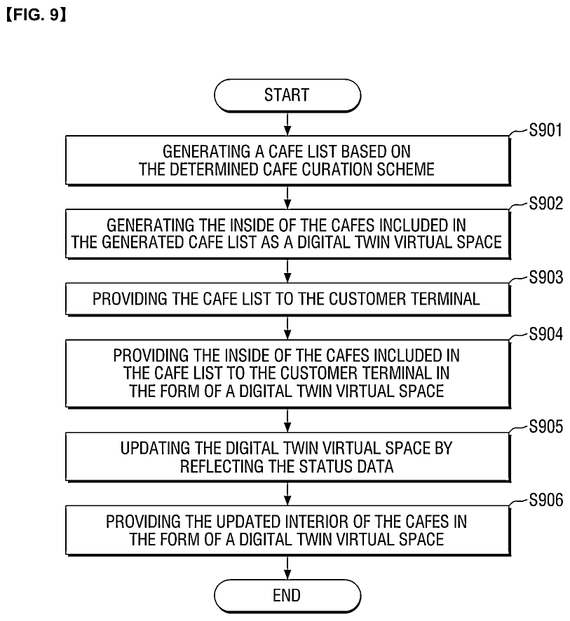

FIG. 8 is a block diagram illustrating a cafe curation device according to an embodiment.

Referring to FIG. 8, a cafe curation device 20 according to one embodiment may include a cafe monitoring data collection module 200, a status check signal transmission module 220, a cafe curation scheme determination module 230, a cafe list generation module 240, a customer data collection module 250, and a digital twin generation module 260. Since the cafe monitoring data collection module 200, status check signal transmission module 220, cafe curation scheme determination module 230, cafe list generation module 240, and customer data collection module 250 have been described previously in relation with FIG. 3, the explanation here will focus primarily on the differences between the embodiment of FIG. 3 and the present embodiment.

The digital twin generation module 260 may create a digital twin virtual space of the interiors of cafes included in the cafe list generated by the cafe list generation module 240, using the status data related to the interior status of the cafe from the cafe monitoring data CMD. In some embodiments, the cafe monitoring data CMD may include, along with the status data, additional data such as the floor plan of the cafe, information on the colors and patterns of the floor, walls, and ceiling inside the cafe, and data on the shape, color, and position of furniture like tables, chairs, and sofas arranged in the space. The digital twin generation module 260 may be implemented in a way that recreates the virtual space based on these data.

The cafe list generation module 240 may operate in conjunction with the digital twin generation module 260 to provide the interiors of the cafes included in the cafe list to the customer terminal 30 in the form of a digital twin virtual space. Specifically, the cafe list generation module 240 may generate a cafe list based on the cafe curation scheme SCM determined by the cafe curation scheme determination module 230, provide it as cafe list data CLD to the digital twin generation module 260 and the customer terminal 30, and the digital twin generation module 260 may use the cafe list data CLD to provide digital twin data DTD, which includes data about the interiors of cafes in the form of a digital twin virtual space, to the customer terminal 30. The customer terminal 30 may render the interiors of the cafes in the form of a digital twin virtual space based on the digital twin data DTD and present them to the customer. This allows the customer to explore and experience the interiors of the recommended cafes from the cafe list in advance, without needing to visit them in person, and select a cafe with an interior that suits their preferences.

In some embodiments, the digital twin generation module 260 may update the digital twin virtual space by reflecting changes in the status data of the cafe monitoring data CMD, as well as changes in data such as the floor plan of the cafe, information on the colors and patterns of the floor, walls, and ceiling inside the cafe, and data on the shape, color, and position of furniture like tables, chairs, and sofas arranged in the space. For example, if the interior of the cafe, including seats, tables, customers, floor, walls, ceiling, etc., is changed and the cafe monitoring data collection module 200 receives updated status data on the changed interior from the artificial intelligence-based cafe monitoring device 10, the digital twin generation module 260 may update the digital twin virtual space based on this status data and provide digital twin data DTD, which includes data about the updated interiors of the cafes in the form of a digital twin virtual space, to the customer terminal 30. This allows customers to accurately experience the cafe interiors in order to make an informed choice when selecting a desired cafe.

In some embodiments, the digital twin generation module 260 may periodically or non-periodically check the cafe monitoring data CMD managed by the cafe monitoring data collection module 200 to detect any changes in the cafe's interior and update the digital twin virtual space if changes are detected. In other embodiments, the artificial intelligence-based cafe monitoring device 10 may detect changes in the cafe's interior and send an interior change notification signal along with the cafe monitoring data CMD to the cafe monitoring data collection module 200, in which case the digital twin generation module 260 may update the digital twin virtual space based on the interior change notification signal.

In some embodiments, the status data and predicted data related to the sound data collected through the sound collection unit 107 described in connection with FIG. 2 may be stored as cafe monitoring data CMD in the cafe monitoring data collection module 200. The digital twin generation module 260 may use the status data and predicted data related to the interiors of the cafes included in the cafe list generated by the cafe list generation module 240 to visually present the digital twin virtual space while simultaneously playing appropriate sounds.

Specifically, the digital twin generation module 260 may include playback sound data in the digital twin data DTD sent to the customer terminal 30, based on information such as the current noise level in the store, the status of music being played in the store, noise change predictions, predictions about the music that will be played in the store, and predictions about the atmosphere inside the cafe, all derived from the cafe monitoring data CMD. Here, the playback sound data may be data related to the sound that will be played together when rendering and visually representing the interior of the cafe in the form of a digital twin virtual space on the customer terminal 30. The customer terminal 30, based on the digital twin data DTD that includes the playback sound data, may render the interior of the cafe in the form of a digital twin virtual space while simultaneously providing the appropriate sound to the customer.

For example, if the noise level of a cafe rendered in the form of a digital twin virtual space is determined to be relatively low, indicating a quiet environment, the digital twin generation module 260 may include playback sound data in the digital twin data DTD in the form of a command or information instructing the customer terminal 30 to play ambient sounds. The customer terminal 30, according to this playback sound data, may obtain the music corresponding to the command or information either locally or over the network and play it simultaneously with the rendering of the cafe's interior. Alternatively, the digital twin generation module 260 may include in the digital twin data DTD the actual audio file of a predetermined length containing ambient sounds as the playback sound data. In this case, the customer terminal 30 can play the sound along with the rendering of the cafe's interior after receiving the playback sound data. In another example, if the genre of the store's music in the cafe rendered in the form of a digital twin virtual space is determined to be mainly rock, the digital twin generation module 260 may include playback sound data in the digital twin data DTD in the form of a command or information instructing the customer terminal 30 to play sounds corresponding to the rock genre. The customer terminal 30, according to this playback sound data, may obtain the music corresponding to the command or information either locally or over the network and play it simultaneously with the rendering of the cafe's interior. Alternatively, the digital twin generation module 260 may include the actual audio file of a predetermined length corresponding to the rock genre as the playback sound data in the digital twin data DTD. In this case, the customer terminal 30 can play the sound along with the rendering of the cafe's interior after receiving the playback sound data.

In some embodiments, the digital twin generation module 260 may update the sound played during the rendering of the digital twin virtual space by reflecting changes in the status data and predicted data related to the sound data collected by the sound collection unit 107 from the cafe monitoring data CMD. The specific method of updating may be performed in a manner similar to the update method described above for changes in the interior. This allows customers to experience the cafe's interior more accurately, aiding in the selection of a desired cafe.

FIG. 9 is a flowchart illustrating a cafe curation method according to an embodiment.

Referring to FIG. 9, a cafe curation method according to an embodiment may include generating a cafe list based on the determined cafe curation scheme in step S901, and generating the inside of the cafes included in the generated cafe list as a digital twin virtual space in step S902. The method may further include providing the cafe list to the customer terminal in step S903, and providing the inside of the cafes included in the cafe list to the customer terminal in the form of a digital twin virtual space in step S904. Additionally, the method may include updating the digital twin virtual space by reflecting the status data in step S905, and providing the updated interior of the cafes in the form of a digital twin virtual space in step S906.

For more detail regarding the cafe curation method according to one embodiment, reference may be made to the descriptions provided above in connection with FIGS. 1 to 8. Therefore, redundant explanations will be omitted here.

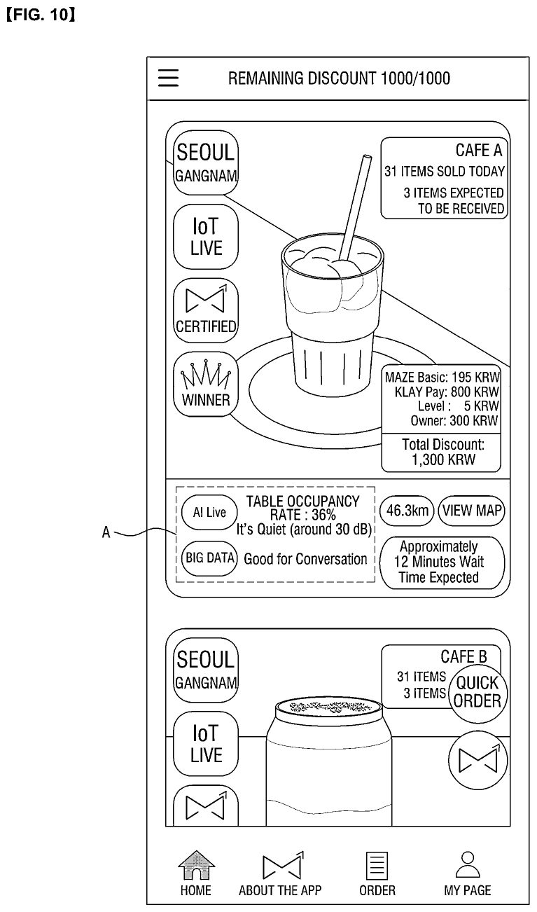

FIG. 10 is a diagram illustrating an example of a screen displayed on a customer terminal according to an embodiment.

Referring to FIG. 10, a screen displayed on the customer terminal according to an embodiment may include a curated cafe list based on the cafe list data CLD provided by the cafe list generation module 240. For example, the screen may display information about “Cafe A” and “Cafe B,” specifically showing representative images of the cafes, sales performance, cafe locations, distances to the cafes, and estimated discount amounts.

The cafe list generation module 240 may provide the current status data and predicted data related to the cafes included in such a cafe list to the customer terminal 30, allowing the customer terminal 30 to display them on the screen in the form of text, icons, images, or videos. For example, referring to area A on the screen, current status data such as “Table Occupancy: 36%” and “(approximately 30 dB)” may be displayed as text, while predicted data such as “Quiet,” and “Good for Conversations” may also be shown as text. Additionally, to the right of area A, another piece of predicted data, “Estimated wait time: approximately 12 minutes,” may be displayed as text.

In some embodiments, when the customer positions a certain cafe list item in the center of the screen or when the customer touches the cafe list item to view detailed information about the currently viewed cafe, rendering may be performed in the form of a digital twin virtual space as previously described in relation with FIG. 8 and FIG. 9.

In some embodiments, when the customer positions a certain cafe list item in the center of the screen or when the customer touches the cafe list item to view detailed information about the currently viewed cafe, rendering may be performed in the form of a digital twin virtual space as previously described in relation to FIG. 8 and FIG. 9, with appropriate sound data being played simultaneously.

In some embodiments, as previously described in relation to FIG. 6 to FIG. 8, whether certain data from the cafe monitoring data CMD has been used may be displayed in the form of text, icons, images, or videos. For example, referring to area A on the screen, if status data from the cafe monitoring data CMD is used, an icon with the text “AI Live” may be displayed, or if predicted data from the cafe monitoring data CMD is used, an icon with the text “Big Data” may be displayed, allowing the user to reference this information when selecting a cafe.

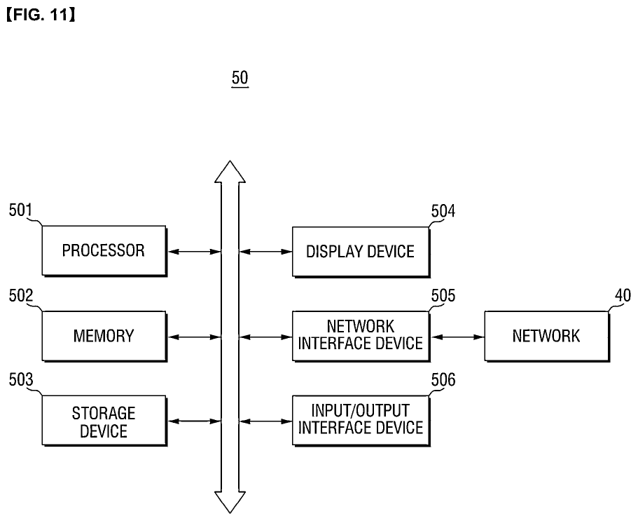

FIG. 11 is a block diagram illustrating a computing device according to an embodiment.

Referring to FIG. 11, an artificial intelligence cafe monitoring device, cafe curation device, customer terminal, and owner terminal according to the embodiments may be implemented using a computing device 50.

The computing device 50 may include at least one of a processor 501, memory 502, storage device 503, display device 504, network interface device 505 providing access to a network 40 for communication with other entities, and an input/output interface device 506 that provides a user input interface or user output interface, all of which communicate via a bus 509. Of course, the computing device 50 may also include any additional electronic devices necessary to implement the technical concepts described in this specification, even though they are not depicted in FIG. 11.

The processor 501 may be implemented in various forms, such as an Application Processor (AP), Central Processing Unit (CPU), Graphic Processing Unit (GPU), or Neural Processing Unit (NPU), and may be any electronic device capable of executing programs or instructions stored in memory 502 or storage device 503. In particular, the processor 501 may be configured to implement the functions or methods described in connection with FIGS. 1 to 10. Additionally, computations related to artificial intelligence in the cafe curation device and cafe curation method according to the embodiments may be processed on the GPU or NPU.

The memory 502 and storage device 503 may include various types of volatile or non-volatile storage media. For example, memory 502 may include ROM (read-only memory) or RAM (random access memory) and may be located either internally or externally to the processor 501, and may be connected to the processor 501 through various means already known. Meanwhile, examples of the storage device 503 include HDD (Hard Disk Drive) or SSD (Solid State Drive), among others. The scope of the present invention is not limited to the elements listed above, which are provided for illustrative purposes.

At least a portion of the cafe curation device and cafe curation method according to the embodiments may be implemented as a program or software executed on the computing device 50. Such programs or software may be stored on a computer-readable medium.

Meanwhile, at least a portion of the cafe curation device and cafe curation method according to the embodiments may be implemented using the hardware of the computing device 50 or as separate hardware that may be electrically connected to the computing device 50.

The embodiments of the present invention have been described in detail above, but the scope of the present invention is not limited to these descriptions. Various modifications and improvements that utilize the basic concepts of the present invention, as defined in the following claims, and that are made by those skilled in the art to which the present invention pertains, are also within the scope of the present invention.

1. A cafe curation device comprising:
a cafe monitoring data collection module configured to collect cafe monitoring data provided from an artificial intelligence-based cafe monitoring device installed in a cafe, wherein the cafe monitoring data includes at least one of status data and predicted data regarding the inside of the cafe;
a customer data collection module configured to collect customer data related to a customer from a customer terminal used by the customer;
a status check signal transmission module configured to transmit a status check signal to the artificial intelligence-based cafe monitoring device;
a cafe curation scheme determination module configured to determine a cafe curation scheme based on a response signal to the status check signal; and
a cafe list generation module configured to generate a cafe list based on the determined cafe curation scheme and provide the cafe list to the customer terminal.

2. The cafe curation device of claim 1, wherein:
the status data includes data related to at least one of table or seat arrangement status, table or seat occupancy status, noise status, status of music being played in a store, status of a playback history of in a store, visiting customer gender status, visiting customer age group status, visiting customer behavior status, visiting customer stay time status, order status by menu, and interior status inside the cafe; and
the predicted data includes data related to at least one of predicted changes in table or seat occupancy rates, predicted seat ambiance, predicted wait times, predicted noise changes, predicted music to be played in the store, predicted visiting customer gender, predicted visiting customer age group, predicted visiting customer behavior patterns, predicted visiting purpose, predicted menu rankings, predicted recommended menu, predicted sales, predicted inventory, and predicted cafe atmosphere.

3. The cafe curation device according to claim 1, wherein the status data and the prediction data are anonymized within the artificial intelligence-based cafe monitoring device.

4. The cafe curation device of claim 1, wherein the customer data includes data related to at least one of customer gender, customer age, customer location, service usage history, customer preferences, preferred menu items, cafe visit history, and predicted visit purpose.

5. The cafe curation device of claim 1, wherein:
a first scheme includes a scheme that uses both the status data and the prediction data for cafe curation, and
when the response signal includes a first response signal, the cafe curation scheme determination module is configured to determine the first scheme as the cafe curation scheme.

6. The cafe curation device of claim 5, wherein:
a second scheme includes a scheme that uses the status data but does not use the prediction data for cafe curation, and
when the response signal includes a second response signal different from the first response signal, the cafe curation scheme determination module is configured to determine the second scheme as the cafe curation scheme.

7. The cafe curation device of claim 6, wherein:
a third scheme includes a scheme that does not use both the status data and the prediction data for cafe curation, and
when the response signal includes a third response signal different from the first response signal and the second response signal, the cafe curation scheme determination module is configured to determine the third scheme as the cafe curation scheme.

8. The cafe curation device of claim 7, wherein:
a fourth scheme includes a scheme that uses past cafe monitoring data collected by the cafe monitoring data collection module for cafe curation, and
when the response signal includes the third response signal, the cafe curation scheme determination module is configured to determine the third scheme and the fourth scheme as the cafe curation scheme.

9. The cafe curation device of claim 8, wherein:
a fifth scheme includes a scheme that uses the customer data for curation, and
the cafe curation scheme determination module is configured to determine at least one of the first scheme through the fourth scheme and the fifth scheme as the cafe curation scheme.

10. The cafe curation device of claim 1, further comprising a digital twin generation module configured to generate the inside of the cafes included in the generated cafe list as a digital twin virtual space, wherein:
the cafe list generation module is configured to operate in conjunction with the digital twin generation module to provide the inside of the cafes included in the cafe list to the customer terminal in the form of the digital twin virtual space.

11. The cafe curation device of claim 10, wherein the digital twin generation module is configured to update the digital twin virtual space by reflecting changes in the status data.

12. The cafe curation device of claim 10, wherein the digital twin generation module is configured to provide sound data corresponding to the inside of the cafes included in the generated cafe list to the customer terminal, allowing the customer terminal to play the sound data during the rendering of the digital twin virtual space.

13. The cafe curation device of claim 12, wherein the digital twin generation module is configured to update the sound data associated with the digital twin virtual space by reflecting changes in the status data.

14. The cafe curation device of claim 1, wherein the cafe list generation module is configured to provide prediction data related to the cafes included in the cafe list to the customer terminal, allowing the customer terminal to display the prediction data on the screen in the form of at least one of text, icons, images, and videos.

15. A cafe curation method comprising:
collecting cafe monitoring data provided from an artificial intelligence-based cafe monitoring device installed in a cafe, wherein the cafe monitoring data includes at least one of status data and prediction data regarding the inside of the cafe;
collecting customer data related to a customer from a customer terminal used by the customer;
transmitting a status check signal to the artificial intelligence-based cafe monitoring device;
determining a cafe curation scheme based on a response signal to the status check signal; and
generating a cafe list based on the determined cafe curation scheme and providing the cafe list to the customer terminal.

16. The cafe curation method of claim 15, further comprising:
creating a digital twin virtual space of the inside of the cafes included in the generated cafe list; and
providing the inside of the cafes included in the cafe list to the customer terminal in the form of the digital twin virtual space.

17. The cafe curation method of claim 16, further comprising:
providing sound data related to the digital twin virtual space to the customer terminal.

18. The cafe curation method of claim 15, further comprising:
providing the prediction data related to the cafes included in the cafe list to the customer terminal, allowing the customer terminal to display the prediction data on the screen in the form of at least one of text, icons, images, and videos.
